(19) United States
(12) Patent Application Publication
(10) Pub. No.: US 2019/0005458 A1
(43) Pub. Date: Jan. 3, 2019

(54) GENERATING SUGGESTED EVENTS WITHIN AN ELECTRONIC CALENDAR

(71) Applicant: Microsoft Technology Licensing, LLC, Redmond, WA (US)

(72) Inventors: Sri Ramya MALLIPUDI, Redmond, WA (US); Hiroshi TSUKAHARA, Bellevue, WA (US); Vignesh SACHIDANANDAM, Seattle, WA (US); Ned B. FRIEND, Seattle, WA (US); Peter L. ENGRAV, Seattle, WA (US)

(21) Appl. No.: 15/637,976

(22) Filed: Jun. 29, 2017

(51) Int. Cl. G06Q 10/10; G06Q 10/02

(52) U.S. Cl. CPC G06Q 10/1093; G06F 17/30386; G06Q 10/025

(57) ABSTRACT

Methods and systems for generating suggested calendar events within an electronic calendar. One system includes an electronic processor configured to access a plurality of data records associated with a user and generate and output an electronic calendar of the user, the electronic calendar including a representation of at least one of the plurality of calendar events. The electronic processor is also configured to determine a suggested calendar event for the user and generate and output a representation of the suggested calendar event within the electronic calendar. The electronic processor is also configured to, in response to the user accepting the suggested calendar event, add a data record for the suggested calendar event to the plurality of data records associated with the user and generate and output an updated version of the electronic calendar of the user based on the plurality of data records.

### FIELD

Embodiments described herein relate to electronic calendars, and, more particularly, to electronic calendar services that generate suggested calendar events.

### SUMMARY

Time management and calendar services and software applications, such as Google Calendar provided by Google, Inc., Outlook provided by Microsoft Corporation, and Calendar provided by Apple, Inc., allow users to create data records representing time-based events, such as doctor appointments, work meetings, task due dates, social events, and the like. An electronic calendar provided through such services displays these time-based events, which may be represented as text, icons, graphics, objects, or the like, within a predetermined time frame, such as a day, a week, a month, and the like. This fixed configuration of events may force a user to scroll or navigate through multiple screens or windows to see relevant tasks. For example, when a user has few events until six months from the current date, the user may be forced to scroll or navigate through multiple screens or windows before reaching relevant events.

Furthermore, as a user must manually add events to the electronic calendar, the electronic calendar may be out-of-date when the user forgets to manually add new events. In addition, to keep track of activities of family members and co-workers, a user may add the events of these other users to their own calendar, such as by creating a shared calendar or by requesting calendar invites for these events. All of these events may clutter a user's electronic calendar and make it difficult for a user to distinguish their own events (or events that they need to attend) from other events that may be included purely for informational purposes.

To address this and other problems with electronic calendars, embodiments described herein generate an electronic calendar that displays a plurality of calendar events within a timeline. In some embodiments, a timeline includes a graphic representation of the passage of time as a line, such as horizontal line. For example, the systems and methods described herein may display calendar events in chronological order along a horizontal line with time information specified along the horizontal line.

The events displayed within the timeline may include future events and historical events. The historical events may also be associated with and displayed with additional data, such as photos taken at the time of such historical events, documents created at the time of such historical events, people met at such historical events, and the like. Accordingly, in addition to providing a streamlined way to view events, the electronic calendar may include information that allows a user to retrace and reminisce about past activities.

In some embodiments, the methods and systems described herein also generate one or more suggested calendar events for a user within an electronic calendar. The suggested calendar event may be based on a stored profile of the user. The stored profile includes information relating to the user, such as one or more user preferences or demographics, a historical calendar event of the user, or a future calendar event of the user. For example, when an electronic calendar of a user includes a future calendar event for a trip, the systems and methods described herein may suggest a calendar event for scheduling a car service to the airport, booking a hotel, stopping mail service, or the like. Similarly, when a user attended a conference last year, the systems and methods described herein may suggest the same conference the next year. The profile of a user may also associate a user with other users, such as family members or co-workers, and the suggested calendar events may be based on preferences or events of these other users. For example, when a user's spouse has a future event within his or her electronic calendar regarding a parent-teacher conference, the systems and methods described herein may suggest the same event for the user.

A user of the electronic calendar may accept or reject a suggested calendar event. For example, to accept a suggested calendar event, a user may drag and drop a representation (icon, object, text, graphic, or the like) of the suggested calendar event into the user's schedule (such as into the timeline included in the electronic calendar). In other embodiments, the electronic calendar may allow a user to select (for example, click on or touch) a representation of a suggested calendar event to accept the event, reject the event, or both (through a drop-down menu or the like). In some embodiments, the representation of a suggested calendar event and the position of the representation prevents the electronic calendar of a user from being cluttered and enables easy interaction with the suggested calendar events (for example, accepting the suggested calendar event or rejecting the suggested calendar event via drag and drop techniques). In some embodiments, a profile of a user is also updated based on whether the user accepts or rejects a suggested calendar event to improve future suggested calendar events. For example, assume a user's profile indicates that the user enjoys jazz music. Based on this information, the systems and methods described herein may generate suggested calendar events for the user for local jazz concerts. In response to the user repeatedly rejecting such suggested calendar events, the systems and methods described herein may update the stored profile of the user to prevent or limit further suggested calendar events relating to jazz.

Accordingly, embodiments described herein provide systems and methods for generating electronic calendars and, in particular, generating suggested calendar events within an electronic calendar. For example, one embodiment of the invention provides a system for generating suggested calendar events within an electronic calendar. The system includes an electronic processor configured to access a plurality of data records associated with a user, each of the plurality of data records including data associated with one of a plurality of calendar events. The electronic processor is also configured to generate and output an electronic calendar of the user, the electronic calendar including a representation of at least one of the plurality of calendar events. The electronic processor is also configured to determine a suggested calendar event for the user and generate and output a representation of the suggested calendar event within the electronic calendar. The electronic processor is also configured to, in response to the user accepting the suggested calendar event, add a data record for the suggested calendar event to the plurality of data records associated with the user and generate and output an updated version of the electronic calendar of the user based on the plurality of data records.

Another embodiment provides a method of generating suggested calendar events within an electronic calendar. The method includes accessing, with an electronic processor, a plurality of data records associated with a user, each of the plurality of data records including data associated with one of a plurality of calendar events. The method also includes generating and outputting, with the electronic processor, an electronic calendar of the user, the electronic calendar including a representation of at least one of the plurality of calendar events. The method also includes determining, with the electronic processor, a suggested calendar event for the user based on a stored profile of the user and generating and outputting, with the electronic processor, a representation of the suggested calendar event within the electronic calendar. The method also includes, in response to the user accepting the suggested calendar event, adding, with the electronic processor, a data record for the suggested calendar event to the plurality of data records associated with the user and generating and outputting, with the electronic processor, an updated version of the electronic calendar of the user based on the plurality of data records. The method also includes updating the stored profile of the user based on whether the user accepts or rejects the suggested calendar event.

Yet another embodiment provides a non-transitory, computer-readable medium including instructions that, when executed by an electronic processor, cause the electronic processor to execute a set of functions. The set of functions includes accessing a plurality of data records associated with a user, each of the plurality of data records including data associated with one of a plurality of calendar events. The set of functions also includes generating and outputting an electronic calendar of the user, the electronic calendar including a representation of at least one of the plurality of calendar events. The set of functions also includes determining a suggested calendar event for the user and generating and outputting, with the electronic processor, a representation of the suggested calendar event within the electronic calendar, the representation of the suggested calendar event distinguished from the representation of the at least one of the plurality of calendar events. The set of functions also includes, in response to the user accepting the suggested calendar event, adding a data record for the suggested calendar event to the plurality of data records associated with the user, and generating and outputting an updated version of the electronic calendar of the user based on the plurality of data records. The set of functions also includes updating a stored profile of the user based on whether the user accepts or rejects the suggested calendar event.

### BRIEF DESCRIPTION OF THE DRAWINGS

FIG. 1 schematically illustrates a system for generating an electronic calendar according to some embodiments.

FIG. 2 is a flowchart illustrating a method of generating suggested calendar events within an electronic calendar performed by the system of FIG. 1 according to some embodiments.

FIGS. 3-6 illustrate an example electronic calendar.

FIG. 7 illustrates an example electronic calendar of a user including a suggested calendar event.

FIGS. 8 and 9 illustrate an example electronic calendar having a foreground layer and a background layer.

FIG. 10 illustrates the example electronic calendar of FIG. 7 after a user accepts the suggested calendar event.

FIG. 11 illustrates an example electronic calendar allowing a user to set a responsible attendee for a calendar event.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory, computer readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, time management and scheduling calendar services and software applications allow users to define and store data records representing time-based events, which can be used to populate an electronic calendar. The electronic calendars are often displayed within a calendar view for a predetermined period of time, such as a day, a week, a month, or the like. This fixed format may make it difficult for a user to view and manage events and may force a user to scroll or navigate through multiple screens or windows to access a relevant portion of the electronic calendar. Accordingly, embodiments described herein provide systems and methods for generating an electronic calendar that displays calendar events within a timeline, which may include both historical events and future events.

To further increase the usability and flexibility of the electronic calendar, events may be displayed differently within the electronic calendar depending on whether the event is a user event, a related-user event, a committed event, or a suggested event. For example, as described in more detail below, a calendar service may be configured to generate suggested calendar events for a user. Icons representing these suggested calendar events can be displayed within the user's electronic calendar. The suggested calendar events may be generated based on a profile of the user, such as the user's preferences, demographics, historical events, future events, and the like. By displaying the suggested calendar events within the user's electronic calendar, a user can quickly determine whether the suggested calendar event fits within the user's schedule and easily add the suggested event to the user's calendar as needed (for example, by dragging and dropping the icon representing the suggested calendar event into the timeline). Furthermore, the calendar service may be configured to learn from a user's acceptance and rejection of suggested calendar events to provide better customized suggestions over time.

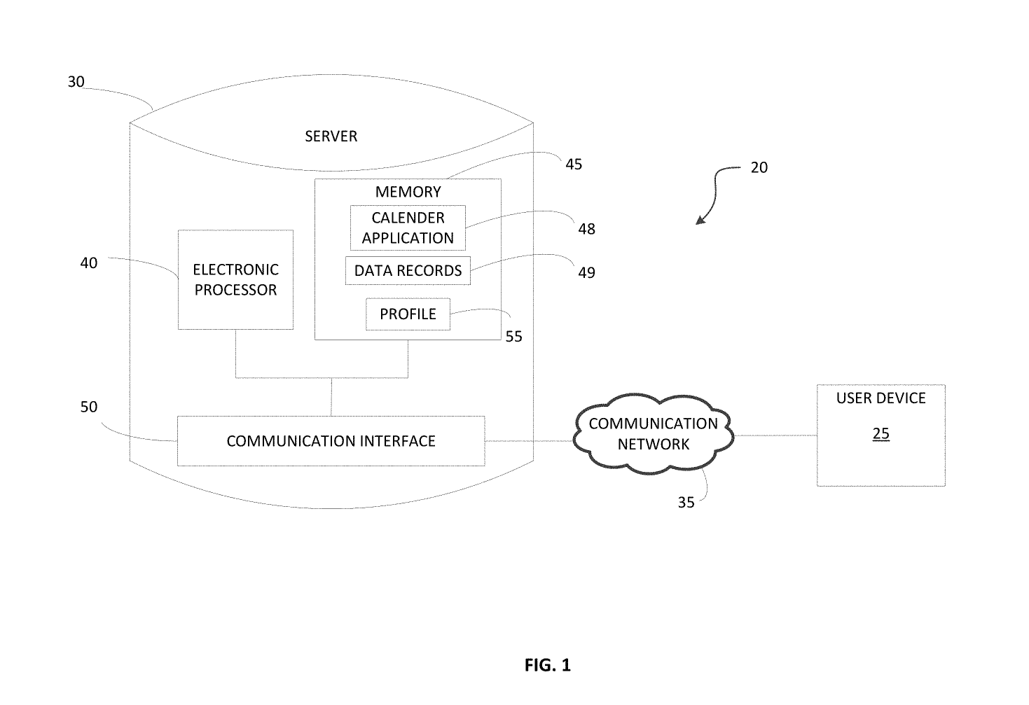

FIG. 1 schematically illustrates a system 20 for generating an electronic calendar. The system 20 includes a user device 25 and a server 30. In some embodiments, the system 20 includes fewer, additional, or different components than illustrated in FIG. 1. For example, the system 20 may include multiple user devices 25, multiple servers 30, or a combination thereof.

The user device 25 and the server 30 communicate over one or more wired or wireless communication networks 35. Portions of the communication networks 35 may be implemented using a wide area network, such as the Internet, a local area network, such as a Bluetooth™ network or Wi-Fi, and combinations or derivatives thereof. Alternatively or in addition, in some embodiments, components of the system 20 communicate directly as compared to through the communication network 35. Also, in some embodiments, the components of the system 20 communicate through one or more intermediary devices not illustrated in FIG. 1.

The server 30 includes a computing device, such as a server, a database, or the like. As illustrated in FIG. 1, the server 30 includes an electronic processor 40, a memory 45, and a communication interface 50. The electronic processor 40, the memory 45, and the communication interface 50 communicate wirelessly, over one or more communication lines or buses, or a combination thereof. The server 30 may include additional components than those illustrated in FIG. 1 in various configurations. For example, the server 30 may also include one or more human machine interfaces, such as a keyboard, keypad, mouse, joystick, touchscreen, display device, printer, speaker, and the like, that that receive input from a user, provide output to a user, or a combination thereof. The server 30 may also perform additional functionality other than the functionality described herein. For example, in some embodiments, the server 30 may provide task management server, messaging services, such as email messaging, and the like in addition to the calendaring services as described herein. Also, the functionality described herein as being performed by the server 30 may be distributed among multiple servers or devices. For example, the calendaring services described herein may be provided through one or more servers included in a cloud service or cloud-computing environment.

The communication interface 50 may include a transceiver that communicates with the user device 25 over the communication network 35 and, optionally, one or more other communication networks or connections. The electronic processor 40 includes a microprocessor, an application-specific integrated circuit (ASIC), or another suitable electronic device for processing data, and the memory 45 includes a non-transitory, computer-readable storage medium. The electronic processor 40 is configured to retrieve instructions and data from the memory 45 and execute the instructions. As illustrated in FIG. 1, the memory 45 includes a calendar application 48. As described in more detail below, the electronic processor 40 executes the calendar application 48 to generate and access data records 49 (also stored in the memory 45) representing time-based events of one or more users, which may be displayed (through one or more representations) within an electronic calendar. The memory 45 may also store one or more user profiles 55 associated with one or more users of the calendar application 48. The electronic processor 40 may access a user profile 55 to customize or configure an electronic calendar generated for a particular user. For example, a user profile 55 may specify colors, font sizes, default reminder settings, icons, and the like to be used within the electronic calendar generated for a user. As also described in more detail below, the user profiles 55 may also include preferences, demographics, and calendar events associated with a user, which the calendar application 48 may use to generate suggested calendar events for a user. For example, a user profile 55 may include a genre of music that the user likes, a hobby of the user, an education of the user, an income of the user, an age of the user, a gender of the user, a geographic location where the user lives, a geographic location where the user works, and the like. In addition, a user profile 55 may include one or more events, such as historical events or future events. These events may be directly included in the profile 55 or may associated with a user through a profile 55.

The preferences and events included in or associated with a user profile 55 may include preferences and events of the user associated with the profile 55, another user (such as a user's family member, friend, or co-worker), or a combination thereof. For example, a user profile 55 may define other users associated with a user, such as the user's spouse, children, manager, friends, and the like. Based on these designations, the calendar application 48 may be configured to access preferences, demographics, and events of these other users (stored on separate user profiles 55).

The user device 25 also includes a computing device, such as a desktop computer, a laptop computer, a tablet computer, a terminal, a smart telephone, a smart television, a smart wearable, or another suitable computing device that interfaces with a user. Although not illustrated in FIG. 1, the user device 25 may include similar components as the server 30, such an electronic processor (for example, a microprocessor, an application-specific integrated circuit (ASIC), or another suitable electronic device), a memory (for example, a non-transitory, computer-readable storage medium), a communication interface, such as a transceiver, for communicating over the communication network 35 and, optionally, one or more additional communication networks or connections, and one or more human machine interfaces. For example, to communicate with the server 30, the user device 25 may store a browser application or a dedicated software application executable by an electronic processor. The system 20 is described herein as providing a calendar service through the server 30. However, in other embodiments, the functionality described herein as being performed by the server 30 may be locally performed by the user device 25. For example, in some embodiments, the user device 25 may store the calendar application 48 and one or more user profiles 55.

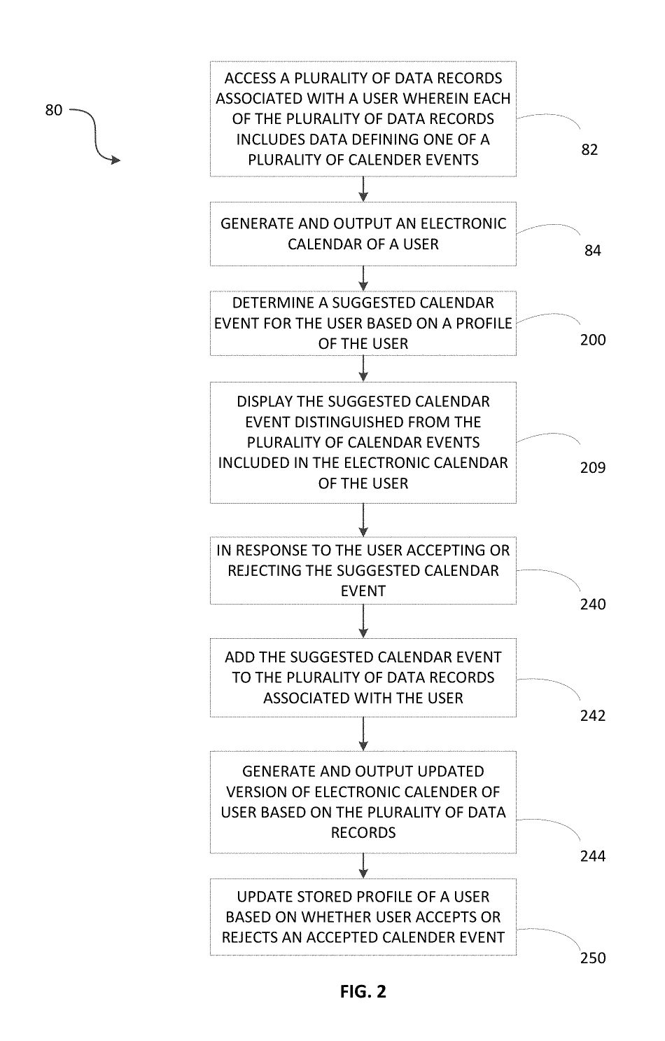

FIG. 2 is a flowchart illustrating a method 80 of generating suggested calendar events within an electronic calendar performed by the system 20. The method 80 is described as being performed by the server 30 and, in particular, the calendar application 48 as executed by the electronic processor 40. However, as noted above, the functionality described with respect to the method 80 may be performed by other devices, such as the user device 25, or distributed among a plurality of devices, such as a plurality of servers included in a cloud service.

As illustrated in FIG. 2, the method 80 includes accessing, with the electronic processor 40, a plurality of data records 49 associated with a user, wherein each of the plurality of data records includes data defining one of the plurality of calendar events (at block 82). As illustrated in FIG. 1, the data records 49 may be stored in the memory 45 of the server 30. However, in other embodiments, the data records 49 (or a set or portion thereof) may be stored on a memory external to the server 30. Each data record 49 may include a title of a calendar event, a date and time of a calendar event (including a start time, an end time, a duration, or a combination thereof), a location of a calendar event, attendees of a calendar event (optional or required), a reminder for a calendar event, a frequency of a calendar event, a type of a calendar event, notes for a calendar event, or a combination thereof. In some embodiments, the electronic processor 40 uses a stored user profile 55 to determine the plurality of data records associated with a user.

The method 80 also includes generating and outputting, with the electronic processor 40, an electronic calendar of the user (at block 84). The electronic calendar includes a representation of at least one of the plurality of calendar events. As used in the present application, a representation includes an icon, object, graphic, text (such as a title of the calendar event), a combination thereof, or the like. The server 30 may output the electronic calendar by transmitting the electronic calendar to the user device 25 over the communication network 35. The user device 25 displays the received electronic calendar to a user through a human machine interface, such as a display or a touchscreen.

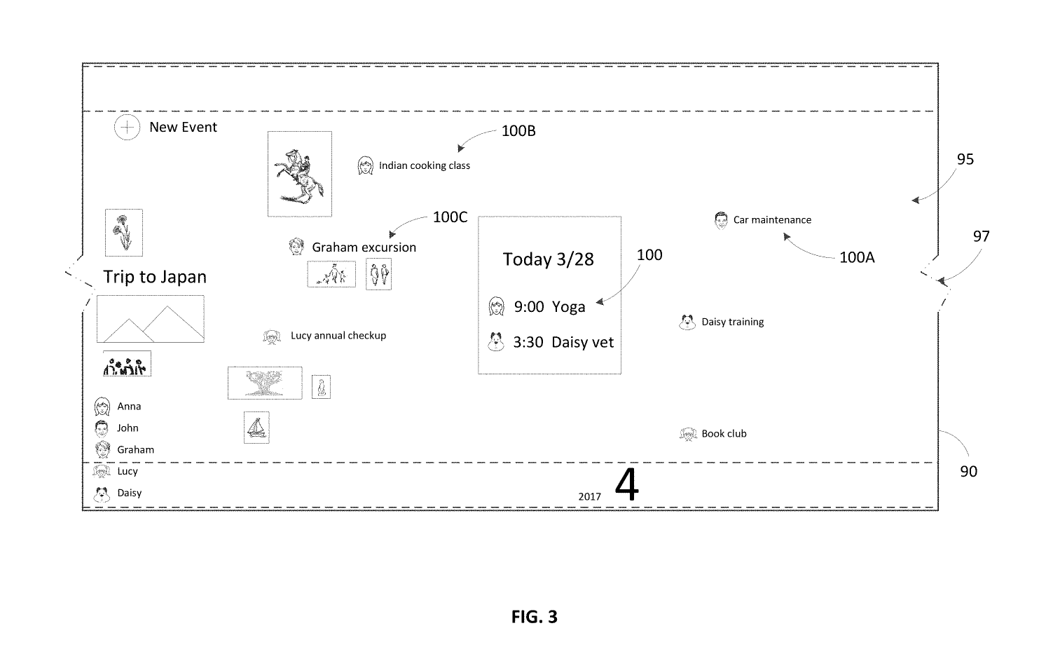

FIG. 3 illustrates an example electronic calendar 95. As illustrated in FIG. 3, the electronic calendar 95 may include a timeline 97, which may be represented as a horizontal line tracking the passage of time (from earlier times on the left to later times on the right). The timeline 97 includes a plurality of representations 100 that represent a plurality of calendar events associated with a user (defined by the data records 49). Each of the representations 100 is positioned chronologically along the timeline 97. In some embodiments, representations 100 for upcoming calendar events, such as events occurring in the next 24 hours, may be marked or otherwise distinguished from other events included in the electronic calendar 95.

Each of the representations 100 may represent a future calendar event or a historical calendar event. A future calendar event is a calendar event that occurs at a future point in time (from a current time), such as tomorrow, next week, and the like. For example, as illustrated in FIG. 3, the representation 100A represents a future calendar event entitled “Car maintenance.” In contrast, a historical calendar event is a calendar event that occurred at a previous point in time (from a current time), such as yesterday, last week, and the like. For example, as illustrated in FIG. 3, the representation 100B represents a calendar event entitled “Indian cooking class” that occurred at a previous point in time.

In some embodiments, the electronic calendar 95 includes representations 100 of calendar events associated with multiple users. For example, a user may share his or her calendar events with other users, such as other family members, friends, co-workers, and the like. In particular, as illustrated in FIG. 3, the electronic calendar 95 includes a representation 100C of a calendar event entitled “Graham excursion” that is associated with a second user (for example, a child of the first user). As also illustrated in FIG. 3, icons or other legends may be used to identify a user associated with each representation 100.

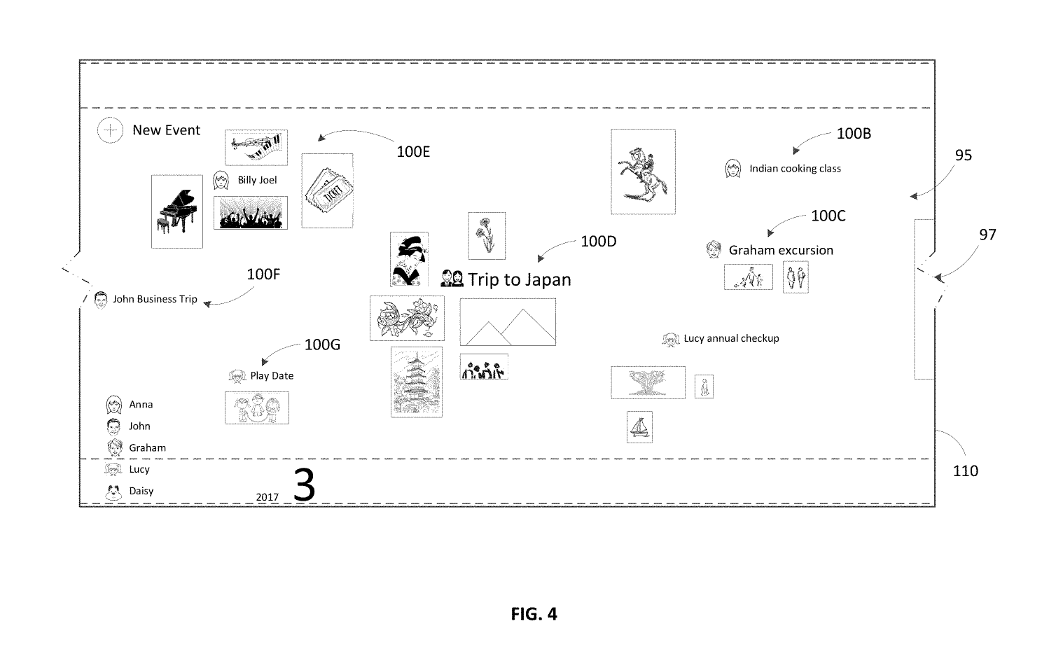

In some embodiments, the timeline 97 is adjustable. For example, by scrolling, swiping, or selecting other input mechanisms, a user may navigate forward or backward along the timeline 97. In other words, the electronic calendar 95 allows a user to change the portion of the timeline 97 currently displayed to the user. For example, in response to a user swiping to the right on a touchscreen of the user device 25, the electronic processor 40 may update the timeline 97 (and the associated representations 100) to include a future point in time. Similarly, in response to a user swiping to the left on the touchscreen, the electronic processor 40 may update the timeline 97 (and the associated representations 100) to include a previous point in time. For example, FIG. 4 illustrates the example electronic calendar 95 illustrated in FIG. 3 scrolled backward along the timeline 97. As compared to FIG. 3, the timeline 97 included in FIG. 4 includes additional historical point in time and associated historical calendar events. For example, the electronic calendar 95 displayed in FIG. 4 includes a representation 100D for a trip calendar event, a representation 100E for a concert calendar event, a representation 100F for a business trip calendar event, and a representation 100G for a play date calendar event, all of which are historical calendar events. As compared to other calendaring services that may allow a user to only view calendar events within predetermined time frames, such as a day, a week, or a month, a user may adjust the timeline 97 to view calendar events for variable time periods.

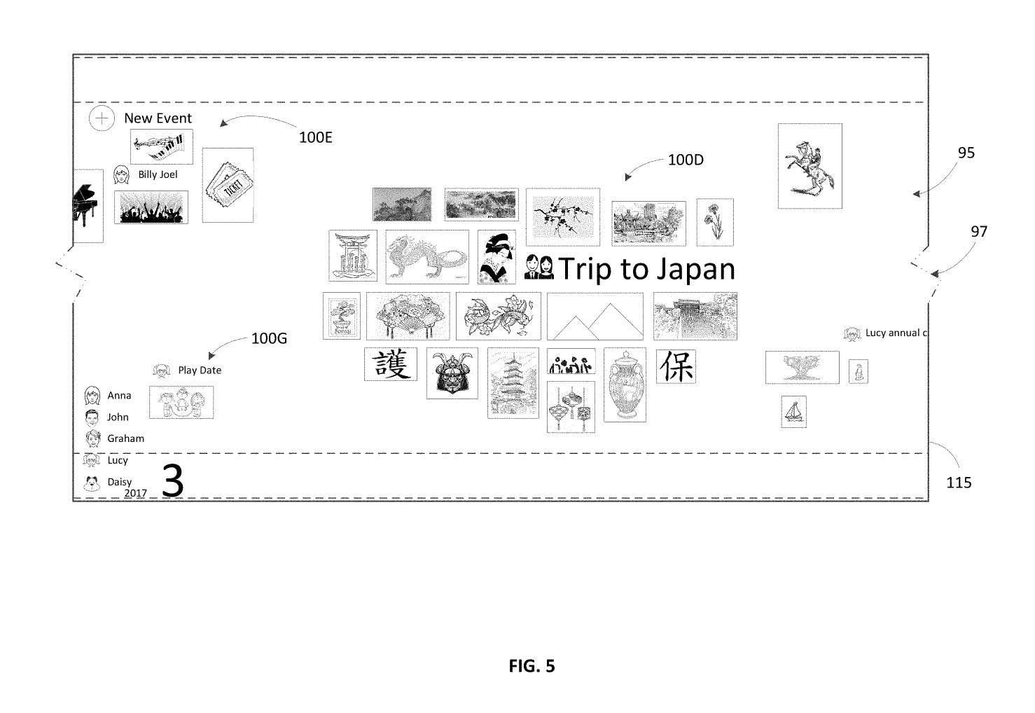

Alternatively or in addition, the electronic calendar 95 may allow a user to change the scale of the timeline 97. For example, a user may be able to zoom the timeline 97 in or out (for example, by pinching open or pinching close the timeline 97 or expanding or selecting one or more input mechanisms) to view a shorter timeline or a longer timeline. In some embodiments, the shorter the timeline, the more detail included in the electronic calendar 95. As one example, in response to the user zooming in on the electronic calendar 95, the electronic calendar 95 may be updated to increase the amount of detail included in the representation 100 of each calendar event. Similarly, when the user zooms out on the electronic calendar 95, the electronic processor 40 decreases the amount of detail of displayed representations 100. For example, FIG. 5 illustrates the example electronic calendar 95 of FIG. 3 zoomed in. In this configuration, as compared to the electronic calendar 95 illustrated in FIG. 3, the representation 100D for the trip calendar event includes further details.

In some embodiments, the amount of detail included in a representation 100 may vary based on an importance level of the associated calendar event. For example, representations 100 for calendar events with a high importance level may be larger and include more detail (data) than representations 100 for calendar events with a lower importance level. For example, as illustrated in FIG. 5, the representation 100D for the trip calendar event may have a higher importance level than the representation 100G for the play date calendar event. The importance level of a calendar event may be set by the user (included in the data record 49 for a calendar event) or determined by the server 30. For example, the server 30 may apply one or more rules (which may be configurable by a user) to set an importance level of a calendar event based on an event type (work or personal), event duration, number of attendees, and the like.

As noted above, the timeline 97 may include historical calendar events. In some embodiments, in addition to including representations 100 of historical calendar events, the timeline 97 also includes representations 110 of additional data associated with a historical calendar event. In some embodiments, a user can configure the electronic calendar 95 to turn on or off the representations 110. Also, in some embodiments, the representations 100 for calendar events are selectable to access additional information for a calendar event including the representations 110.

The representations 110 are selectable by a user and represent data, such as images, videos, data files, contact entries, and the like associated with a historical calendar event. An image associated with a historical calendar event of the user may include, for example, an image taken by the user at the time of the historical calendar event, an image associated with the historical calendar event, an image edited by the user at the time of the historical calendar event, an image taken by the user at a location associated with the historical calendar event, and the like. A video associated with the historical calendar event of the user may include, for example, a video taken by the user at the time of the historical calendar event, a video associated with the historical calendar event, a video edited by the user at the time of the historical calendar event, a video taken by the user at a location associated with the historical calendar event, and the like. A data file associated with the historical calendar event of the user may include, for example, a data file created by the user at the time of the historical calendar event, a data file associated with the historical calendar event, a data file edited by the user at the time of the historical calendar event, a data file created by the user at a location associated with the historical calendar event, a data file edited by the user at a location associated with the historical calendar event, or the like. A contact entry associated with a historical calendar event may be a contact entry for another user that the user interacted with at the time of the historical calendar event, a contact entry another user associated with the historical calendar event, a contact entry for another user that the user interacted with at a location of the historical calendar event, and the like. For example, contact entries associated with a historical calendar event may include identifiers of the other attendees of a historical calendar event. As another example, a contact entry associated with a historical calendar event may include identifiers of individuals the user communicated with (for example, via email or telephone) at the time of the historical calendar event.

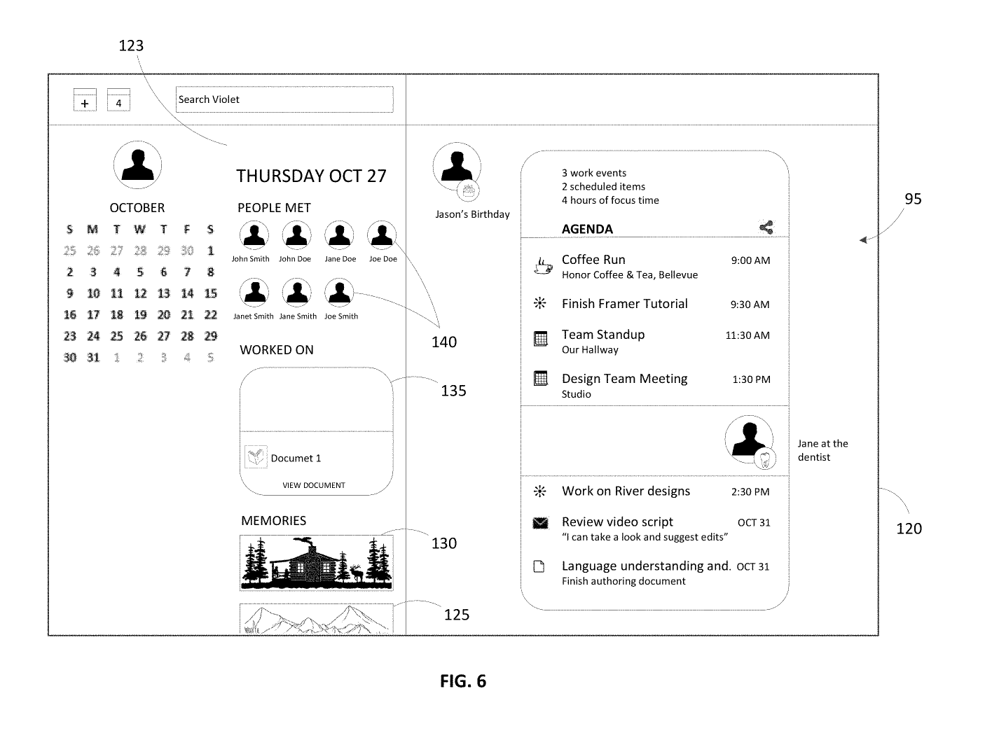

For example, FIG. 6 is an example electronic calendar 95 including a representation 120 of a historical calendar event as well as a plurality of representations 123 representing additional data for the historical calendar event. In the example illustrated in FIG. 6, the representations 123 include a representation 125 of an image, a representation 130 of a video, a representation 135 of a data file, and a plurality of representations 140 of contact entries. As illustrated in FIG. 6, the representations 140 represent contact entries for other users that the user met with or otherwise were involved with the historical calendar event. Similarly, the representation 135 represents a data file (document file) that the user created, opened, or edited on the date of the historical calendar event. In addition, the representation 125 represents an image taken by the user on the date of the historical calendar event, and the representation 130 represents a video taken by the user on the date of the historical calendar event. A user may select one of the representations 125, 130, 135, and 140 to access or open the associated data, such as viewing the image, playing the video, opening the data file, or opening contact entries. Accordingly, the data associated with a historical calendar event may further enhance a user's ability to revisit and reminisce about the historical activities.

In some embodiments, the server 30 obtains the additional data for a historical calendar event from the user device 25 or other sources. For example, the server 30 may communicate with a social media network to obtain or link to images or videos uploaded by the user (or other attendees of the calendar event). Similarly, the server 30 may communicate with a document management system to obtain or link to data files accessed by the user. Also, in some embodiments, the server 30 may consider a browsing history of the user (through a browser application executed by the user device 25) or purchasing history of the user (through a payment management application—an online banking application, an online payments system, such as PayPal®, or the like—or a browser application executed by the user device 25) when compiling the additional data for a historical calendar event.

Returning to the method 80 of FIG. 2, the electronic processor 40 also determines a suggested calendar event for the user (at block 200). In some embodiments, the electronic processor 40 uses a stored profile 55 for the user to determine the suggested calendar event. As described above, a profile 55 of a user includes a collection of data related to the user, such as a preference of the user, a demographic of the user, a location of the user, a historical event of the user, a future event of the user, an event of another user, or a combination thereof. This data may be included in the stored profile 55 or associated and accessible based on data included in the stored profile 55. For example, a profile 55 may associate a user with particular calendar events, including historical and future calendar events of the user or other users.

For example, when a profile 55 indicates that a user likes rock music and lives in San Diego, Calif., the suggested calendar event determined by the electronic processor 40 may relate to rock concert scheduled to take place in San Diego, Calif. next month. As another example, when a profile 55 indicates that a user previously attended a conference that reoccurs in the upcoming month, the suggested calendar event determined by the electronic processor 40 may relate to the upcoming reoccurrence of the conference. Alternatively or in addition, in some embodiments, the suggested calendar event for a user is a reminder based on a future calendar event for the user. For example, when a user has a future calendar event associated with a trip, the suggested calendar event may be a reminder to renew a passport of the user, to book a flight, to book a hotel, and the like. The electronic processor 40 may apply one or more rules to generate such reminders at predetermined times prior to a calendar event (for example 30 days prior to a scheduled trip departure). As another example, when a profile 55 indicates that a family member's birthday is coming up, the suggested calendar event may be a reminder to buy a gift for the family member, to send a card to the family member, to call the family member, and the like.

In addition to profiles 55 and calendar events (data records 49), the server 30 may access additional data sources to determine a suggested calendar event. For example, the server 30 may access one or more database storing information regarding events, such as upcoming events for particular geographical locations. The server 30 may access these data sources directly or through a communications network, such as the communication network 35.

After the suggested calendar event is determined, the calendar application 48 generates and outputs a representation of the suggested calendar event within the electronic calendar 95 (at block 209). The representation of the calendar event may be distinguished from the representations 100 for other (committed) calendar events included in the electronic calendar 95. For example, representations of suggested calendar events may be displayed in a different location within the electronic calendar 95, a different color, a different front, a different size, a different format, or the like.

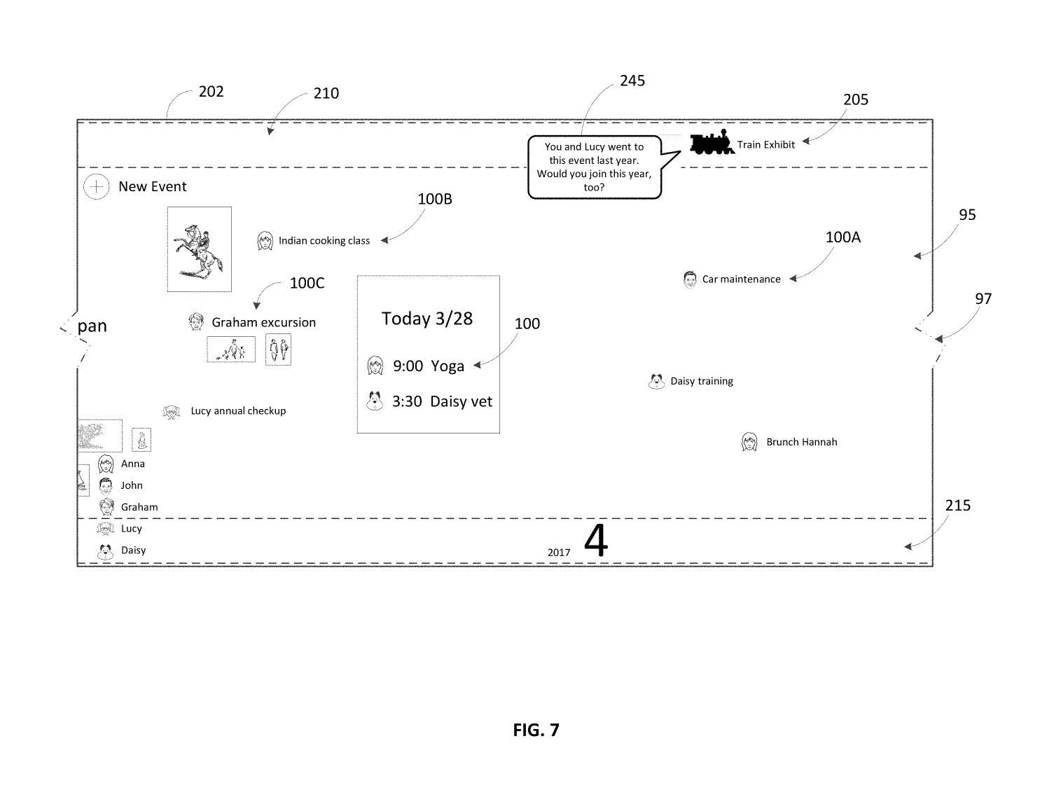

For example, FIG. 7 illustrates an example electronic calendar 95 including a representation 205 of a suggested calendar event (an upcoming reoccurrence of a train exhibit). As illustrated in FIG. 7, the representation 205 is distinguished from the representations 100 as the representation 205 is displayed in a different position than the representations 100. For example, in some embodiments, the electronic calendar 95 includes the timeline 97, a top panel 210, and a bottom panel 215 as illustrated in FIG. 7. The representations 100 are displayed within the timeline 97 and the representations 205 are displayed within the top panel 210, the bottom panel 215, or both. In some embodiments, whether a representation 205 is displayed within the top panel 210 or the bottom panel 215 indicates characteristics of a suggested calendar event. For example, a representation 205 may be displayed in the top panel 210 when the suggested calendar event is a recommendation of a future event, and the representation 205 may be displayed in the bottom panel 215 when the suggested calendar event is a reminder based on a future calendar event. Also, in some embodiments, representations 205 for recently-determined suggested calendar events may be displayed within the top panel 210 and representations 205 for previously-determined suggested calendar events may be displayed within the bottom panel 215.

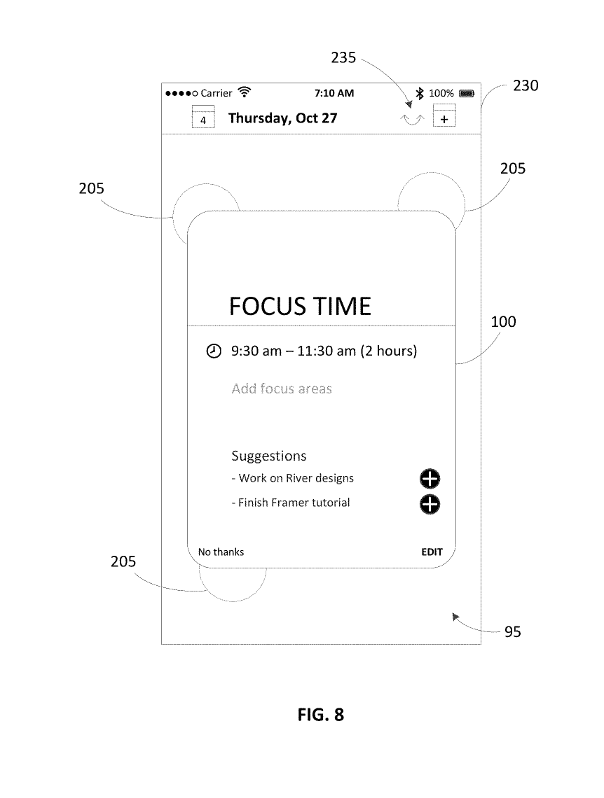

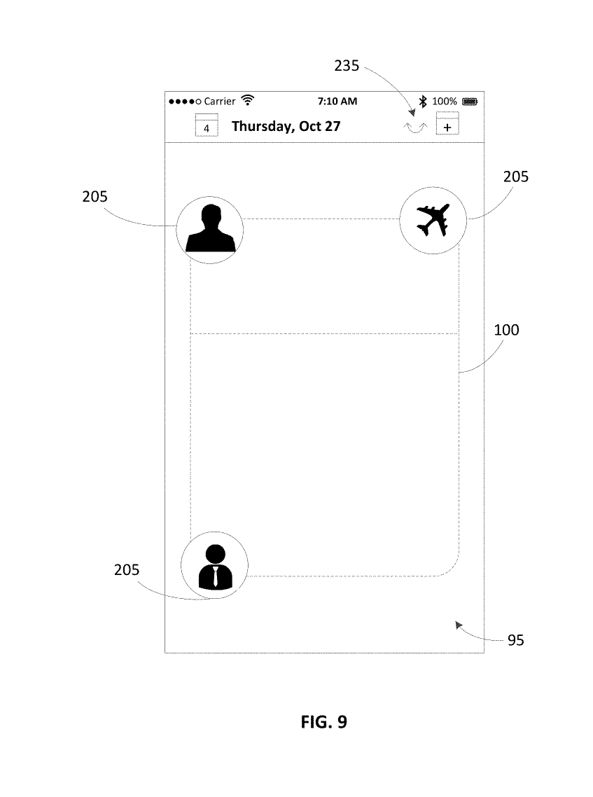

Alternatively or in addition, in some embodiments, the representations 205 are distinguished from the representations 100 by displaying the representations 205 in a background layer of the electronic calendar 95 and displaying the representations 100 in a foreground layer of the electronic calendar 95. For example, FIG. 8 illustrates an example electronic calendar 95 including a foreground layer and a background layer. As illustrated in FIG. 8, the foreground layer is at least partially transparent to allow a user to see the background layer. In this configuration, the representations 205 associated with suggested calendar events may be displayed in the background layer to not distract the user from the representations 100 included in the foreground layer. To more clearly view or interact with the representations 205 included in the background layer, a user may select a navigation button 235 as illustrated in FIG. 8. Alternatively or in addition, the user may directly interact with the background layer to more clearly view or interact with the representations 205. For example, a user may navigate to the background layer by selecting (for example, clicking or touching) the background layer.

In some embodiments, the electronic processor 40 may similarly separate different calendar events between the foreground layer and the background layer. For example, representations 100 for calendar events associated with other users, relating to general events or holidays (a co-worker's birthday), or having a low importance level, may be displayed within the background layer to not distract a user from more important calendar events represented within the foreground layer.

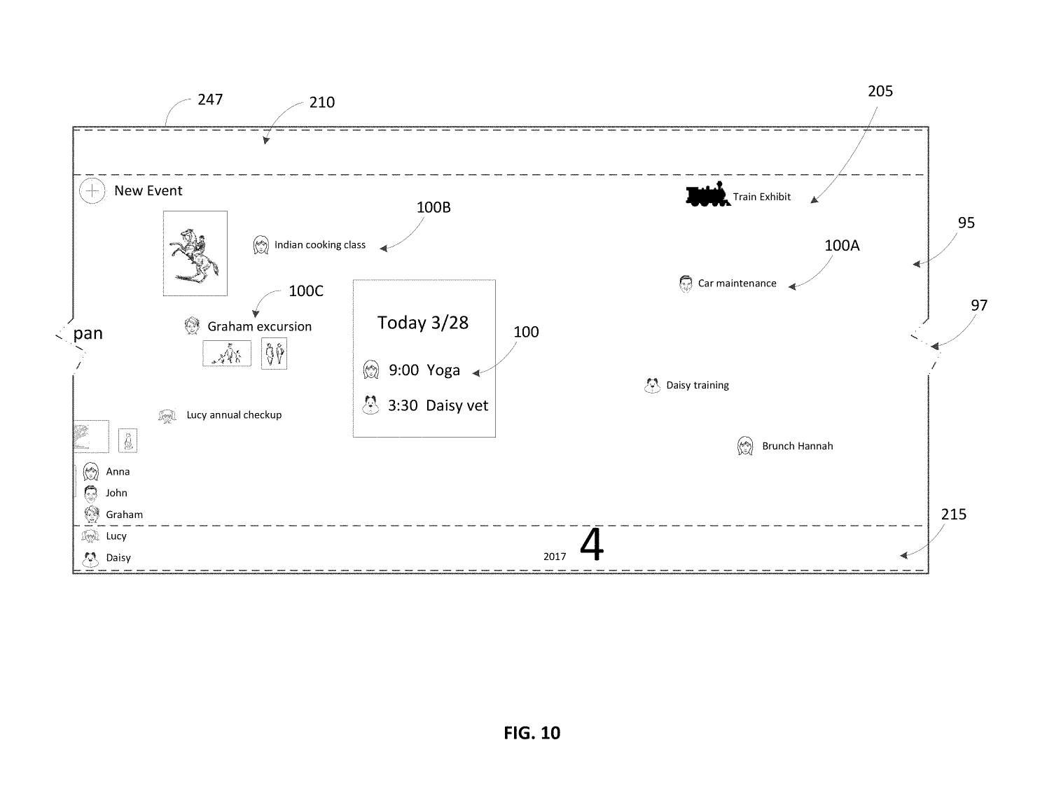

Returning to the method 80 of FIG. 2, in response to the user accepting the suggested calendar event (at block 240), the electronic processor 40 adds a data record for the suggested calendar event to the plurality of data records associated with the user (at block 242) and generates and outputs an updated version of the electronic calendar of the user based on the plurality of data records (at block 244). For example, FIG. 10 illustrates the electronic calendar 95 of FIG. 7 updated in response to a user accepting the suggested calendar event associated with the representation 205. As illustrated in FIG. 10, after a suggested calendar event is accepted, a representation 100 may be displayed for the accepted suggested calendar event similar to the representations 100 for other committed calendar events as described above. In other words, the suggested calendar event may no longer be distinguished from the committed events. In other embodiments, however, the representation 100 for an accepted suggested calendar event may include an identifier that the event resulted from or originated from a suggested calendar event.

In some embodiments, a user accepts a suggested calendar event through a dialogue box 245 (see FIG. 7) that allows a user to accept, reject, or both a suggested calendar event. Alternatively or in addition, a user may accept a suggested calendar event by dragging and dropping the representation 100 of the suggested calendar event into the timeline 97. A user may reject a suggested calendar event by ignoring a representation 205 of the event displayed within the electronic calendar 95.

The electronic processor 40 is also configured to update the stored profile 55 of a user based on whether a user accepts or rejects a suggested calendar event (at block 250). For example, when a user rejects a suggested calendar event, the electronic processor 40 may update the profile 55 of the user by removing or modifying data included in the profile 55 that triggered the suggested calendar event. Similarly, when the user accepts a suggested calendar event, the electronic processor 40 may update the profile 55 of the user by adding or modifying data included in the profile 55 that triggered the suggested calendar event. Accordingly, the electronic processor 40 may use the user's response to suggested calendar events as feedback to improve the acceptance of subsequent suggested calendar events.

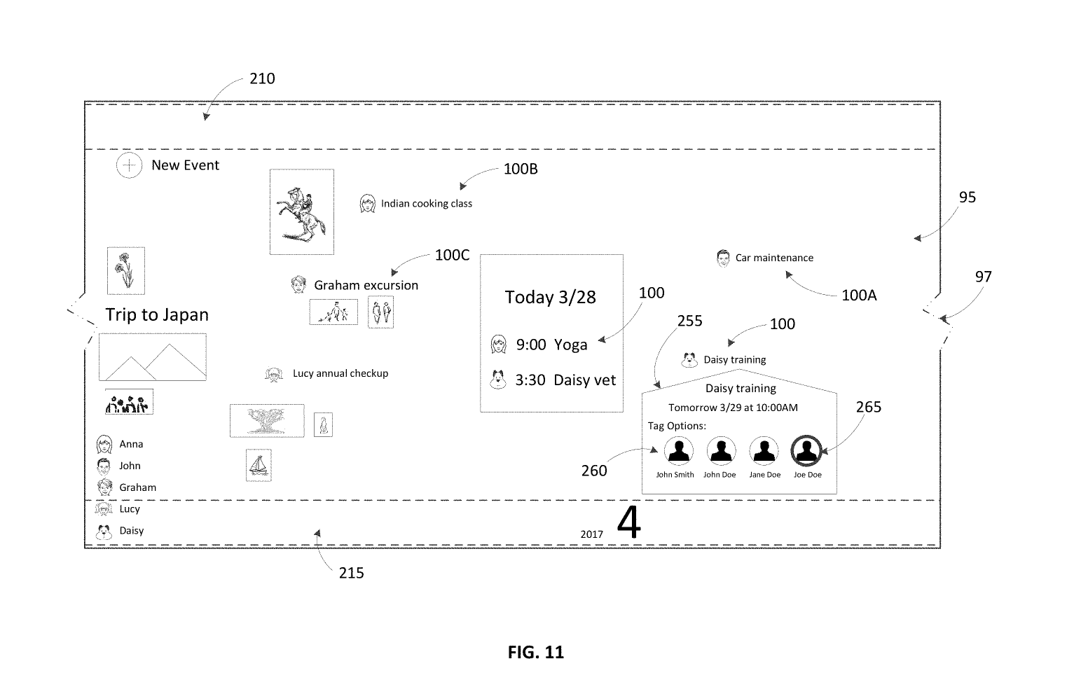

As noted above, in some embodiments, multiple users (attendees) may be associated with a calendar event. However, in some embodiments, only a subset (one) of these users may be responsible for the calendar event. For example, a husband and a wife may both be attendees of a calendar event for picking up a child at school to keep the couple informed of the child's school schedule. Each day, however, only one spouse may be responsible for actually picking up the child from school. Accordingly, in some embodiments, the electronic processor 40 allows a user of the electronic calendar 95 to set a responsible attendee for a calendar event. For example, as illustrated in FIG. 11, when a user selects a representation 100 of a calendar event, the electronic processor 40 may display a dialogue box 255. The dialogue box 255 may include additional data associated with the calendar event, such as a time of the calendar event, a date of the calendar event, and the like. In addition, the dialogue box 255 includes a listing 260 of users. The listing 260 may list other attendees for the calendar event, individuals associated with the user (such as a friend, a family member, a spouse, a co-worker, and the like), or a combination thereof. The user may select one or more users from the listing 260 as the responsible attendee for the calendar event. For example, using the above example, a wife may assign the husband as the responsible attendee through the dialogue box 255 when the wife is unable to pick up the child from school. In some embodiments, when the responsible attendee for a calendar event is modified, the electronic processor 40 generates and transmits one or more notifications (an email message, a text message, and the like) to the responsible attendee. The electronic processor 40 may also notify responsible attendees within the attendee's electronic calendar 95.

As noted above, the functionality of the calendar application 48 is described above as being provided through the server 30. However, all or a portion of the functionality may be provided locally on the user device 25. For example, in some embodiments, the user device 25 may execute the calendar application 48 as described above to generate and output an electronic calendar 95 to a user. The user device 25 may similarly execute the calendar application 48 to determine suggested calendar events as described above. In other embodiments, however, the user device 25 may communicate with the server 30 to receive suggested calendar events. Similarly, the profiles 55 described above may be stored on the server 30, the user device 25, or a combination thereof.

Thus, embodiments described herein provide, among other things, systems and methods for generating an electronic calendar and generating suggested calendar events within the electronic calendar. The suggested calendar events may be based on a profile of a user, existing calendar events of the user, or preferences and existing calendar events of other users. By suggesting calendar events within a user's electronic calendar, a user can quickly determine whether the event fits within his or her schedule and add the event to the user's schedule as applicable. The electronic calendar may provide additional functionality to aid a user in filtering calendar events, setting responsible attendees, or tracking historical activities.

Various features and advantages of some embodiments are set forth in the following claims.

What is claimed is:

1. A system for generating suggested calendar events within an electronic calendar, the system comprising:
an electronic processor configured to
access a plurality of data records associated with a user, each of the plurality of data records including data associated with one of a plurality of calendar events,
generate and output an electronic calendar of the user, the electronic calendar including a representation of at least one of the plurality of calendar events,
determine a suggested calendar event for the user,
generate and output a representation of the suggested calendar event within the electronic calendar, and
in response to the user accepting the suggested calendar event,
add a data record for the suggested calendar event to the plurality of data records associated with the user, and
generate and output an updated version of the electronic calendar of the user based on the plurality of data records.

2. The system of claim 1, wherein the electronic calendar includes a timeline, the representation of the at least one of the plurality of calendar events positioned in a chronological order along the timeline.

3. The system of claim 1, wherein the plurality of calendar events includes a historical calendar event and wherein the electronic calendar includes selectable representations of additional data associated with the historical calendar event, the additional data including at least one selected from a group consisting of an image associated with the historical calendar event, a video associated with the historical calendar event, a contact entry associated with the historical calendar event, and a data file associated with the historical calendar event.

4. The system of claim 3, wherein the electronic processor is further configured to receive at least a portion of the additional data from a social media network.

5. The system of claim 1, wherein the electronic processor is configured to determine the suggested calendar event for the user based on a stored profile of the user, the stored profile of the user including at least one selected from a group consisting of a preference of the user, a demographic of the user, and a geographic location of the user.

6. The system of claim 1, wherein the electronic processor is configured to determine the suggested calendar event for the user based on at least one historical calendar event of the user.

7. The system of claim 1, wherein the electronic processor is configured to determine the suggested calendar event for the user based on at least one future calendar event of the user.

8. The system of claim 1, wherein the electronic processor is configured to determine the suggested calendar event for the user based on at least one calendar event of a second user.

9. The system of claim 1, wherein the electronic processor is further configured to update a stored profile of the user based on whether the user accepts or rejects the suggested calendar event.

10. The system of claim 1, wherein the electronic calendar includes a foreground window and a background window and wherein the representation of the at least one of the plurality of calendar events is displayed in the foreground window and the representation of the suggested calendar event is displayed in the background window.

11. A method of generating suggested calendar events within an electronic calendar, the method comprising:
accessing, with an electronic processor, a plurality of data records associated with a user, each of the plurality of data records including data associated with one of a plurality of calendar events;
generating and outputting, with the electronic processor, an electronic calendar of the user, the electronic calendar including a representation of at least one of the plurality of calendar events;
determining, with the electronic processor, a suggested calendar event for the user based on a stored profile of the user;
generating and outputting, with the electronic processor, a representation of the suggested calendar event within the electronic calendar;
in response to the user accepting the suggested calendar event,
adding, with the electronic processor, a data record for the suggested calendar event to the plurality of data records associated with the user, and
generating and outputting, with the electronic processor, an updated version of the electronic calendar of the user based on the plurality of data records; and
updating the stored profile of the user based on whether the user accepts or rejects the suggested calendar event.

12. The method of claim 11, wherein determining the suggested calendar event for the user based on the stored profile includes determining the suggested calendar event based on at least one selected from a group consisting of a preference of the user, a demographic of the user, and a geographic location of the user.

13. The method of claim 11, further comprising determining the suggested calendar event for the user based on at least one historical calendar event of the user.

14. The method of claim 11, further comprising determining the suggested calendar event for the user based on at least one future calendar event of the user.

15. The method of claim 11, further comprising determining the suggested calendar event for the user based on at least one calendar event of a second user.

16. A non-transitory, computer-readable medium including instructions, that when executed by an electronic processor, perform a set of functions, the set of functions comprising:
accessing a plurality of data records associated with a user, each of the plurality of data records including data associated with one of a plurality of calendar events;
generating and outputting an electronic calendar of the user, the electronic calendar including a representation of at least one of the plurality of calendar events;
determining a suggested calendar event for the user;
generating and outputting, with the electronic processor, a representation of the suggested calendar event within the electronic calendar, the representation of the suggested calendar event distinguished from the representation of the at least one of the plurality of calendar events;
in response to the user accepting the suggested calendar event,
adding a data record for the suggested calendar event to the plurality of data records associated with the user, and
generating and outputting an updated version of the electronic calendar of the user based on the plurality of data records; and
updating a stored profile of the user based on whether the user accepts or rejects the suggested calendar event.

17. The computer-readable medium of claim 16, wherein the representation of the suggested calendar event is distinguished from the representation of the at least one of the plurality of calendar events based on at least one selected from a group consisting of a location within the electronic processor, a color, a font, a size, and a format.

18. The computer-readable medium of claim 16, wherein determining the suggested calendar event for the user includes determining the suggested calendar event based on the stored profile of the user.

19. The computer-readable medium of claim 16, wherein determining the suggested calendar event for includes determining the suggested calendar event based on at least one of the plurality of calendar events.

20. The computer-readable medium of claim 16, further comprising receiving input from the user through the electronic calendar associated with one of the plurality of calendar events, the one of the plurality of calendar events associated with the first user and a second user and wherein the input designates one of the first user and the second user as a responsible attendee for one of the plurality of calendar events.
